(19) United States
(12) Patent Application Publication
(10) Pub. No.: US 2009/0320758 A1
(43) Pub. Date: Dec. 31, 2009

(54) Method and device for the more efficient usage of milking technology in Big, Multistation Milking Plants

(76) Inventors: Marcelo Barba, Alverskirchen (DE); Dieter Meier, Oelde (DE)

Correspondence Address: SMITH LAW OFFICE, 8000 EXCELSIOR DRIVE, SUITE 301, MADISON, WI, 53717, US

(21) Appl. No.: 12/310,934

(22) PCT Filed: Sep. 10, 2007
(86) PCT No.: PCT/EP2007/059483

§ 371 Date: May 18, 2009

(30) Foreign Application Priority Data
Sep. 12, 2006 (DE) 10 2006 043 541.9

(51) Int. Cl. A01J 5/007; A01J 5/00

(52) U.S. Cl. 119/14.02; 119/14.03

(57) ABSTRACT

The invention relates to a method and an apparatus for milking at least one animal, particularly cows, in a multi-position milking installation.

The subject matter of the invention relates to a method and an apparatus for milking at least one animal, particularly cows, in a multi-position milking installation.

Although the invention is subsequently described in connection with a multi-position milking installation for milking cows, it is expressly pointed out that the subject matter of the invention is suitable particularly for use when milking sheep, goats, llamas, camels, dromedaries, buffalo, mares, donkeys, yaks and other lactating animals.

In order to milk animals, particularly cows, multi-position milking installations have been developed in order to increase efficiency and to reduce the effort associated with milking an animal. The multi-position milking installations may be those which are of fixed or moving design. Fixed multi-position milking installations are understood to mean particularly group milking parlours. In the group milking parlour, animals are positioned stationary at the appropriate milking positions.

In the case of moving multi-position milking installations, animals are moved during the milking operation. To this end, the animals stand on a moving base or a moving platform. A representative of such a multi-position milking installation is a carousel milking installation, for example. DE 43 30 894 C1 describes the form of a carousel milking installation by way of example. The carousel milking installation has an entrance area and an exit area. The milking positions are arranged on a moving platform which can rotate about an axis such that the individual milking positions are moved past the entrance area and the exit area. In this case, the movement of the platform is chosen such that the animals can take up the individual free milking positions individually from the entrance area. They leave said milking positions via an exit area after the milking operation has been concluded.

The carousel milking installation known from the document DE 43 30 894 C1 has a control and drive device. The control and drive device is used to vary the speed of rotation on the basis of whether or not the milking operation has been terminated at particular inspection points.

The animals can be positioned differently both in the case of fixed multi-position milking installations and in the case of moving multi-position milking installations. Thus, herringbone milking parlours are known, for example. When the animals are arranged with their sides next to one another, these are referred to as side-by-side milking parlours. When the animals are arranged behind one another, this is referred to as a tandem milking parlour.

US 2002/033138 A1 discloses a method for milking at least one animal, particularly cows, in a multi-position milking installation. The multi-position milking installation is a milking carousel. The milking carousel is moved in steps. For milking purposes, the animals are transferred from a pasture to an entrance area. From the entrance area, the animals move to appropriate milking positions on the carousel milking installation. Four animals at a time move to the milking positions. The platform of the carousel milking installation is moved 30° clockwise, so that the animals which are at the positions enter an area in which the animals' udders are cleaned. In the meantime, further animals move onto the milking platform. The milking platform is moved a further 30°, so that the animals whose udders have been cleaned enter a teat-cup cluster attachment area. When the milking platform has been moved on in steps and the milking operation has ended, the animals leave the milking platform via the exit area.

EP 1 523 880 A2 describes a feeding and milking device with a moving platform. The platform has a few feeding positions to which the animals can move. The animals remain on the moving platform. During the time in which the animals on the platform are moving, they are fed. If necessary, a milking operation takes place.

The use of milking parlours which have a multiplicity of milking positions is intended particularly to increase the milking capacity of the milking installation, i.e. the number of milking operations performed in a prescribed time. The result of this is that the speed at which the carousel moves also needs to be increased. Particularly in the case of large milking carousels, increasing the speed at which the carousel moves results in the drawback that during the time which for performing the routine operations for udder preparation the carousel covers a much longer distance before the teat-cup clusters are attached than is the case with smaller milking carousels. In large milking carousels, the teat-cup cluster is not attached to the udder until relatively far away from the carousel entrance. This circumstance can result in far more teat-cup clusters or milking positions not being used effectively for milking in the case of larger milking carousels than is the case in smaller milking carousels.

Against this background, the present invention is based on the objective of specifying a method and an apparatus for milking animals which allow the efficiency of the milking installation to be increased.

The invention achieves this object by means of a method having the features of claim 1 and by means of an apparatus having the features of claim 4. Advantageous developments and embodiments of the method according to the invention and of the apparatus according to the invention are the subject matter of the dependent claims.

In accordance with the method according to the invention for milking at least one animal, particularly cows, in a multi-position milking installation, it is proposed that the at least one animal be transferred to a preparation area. The term “transfer” can be understood to mean both passive and active guidance of the animal. Thereafter, at least one action preparing for a milking operation is performed in the preparation area. The action preparing for a milking operation can be performed manually, semi-automatically or fully automatically.

When the preparatory actions have been performed on the animal, the animal is transferred from the preparation area to a milking area of the multi-position milking installation. A milking area is understood to mean the area in which the milking operation is performed. In this case, the milking operation can take place in individual milking boxes or at milking positions, regardless of how the animals are arranged relative to one another. To perform the milking operation, a teat-cup cluster is attached to the teats of the animal which is in the milking area. The attachment operation can be performed manually or automatically.

By virtue of at least one action preparing for a milking operation being performed on the animal in the preparation area, it is no longer necessary for the operator to cover long distances, which are time-consuming, for example in order to perform the preparatory actions on the animals at the individual milking positions in a carousel milking installation. This provides the operator with additional time within which the operator can perform the preparatory actions. The effect achieved by the invention is that the teat-cup clusters are already attached to the udder one or two milking positions after the carousel entrance, and therefore the milking system can be used more effectively.

A preparatory action can also be understood to mean the recognition of diseases, particularly diseases of the udder. If it is found that the animal has a disease, particularly a disease of the udder, for example, then this animal can be singled out from the normal milking routine, so that it is no longer brought to the milking installation, for example. Instead, the animal is milked into a milking pail or using a separate milking apparatus.

The udder preparation in a preparation area furthermore improves the general view of the cow and the possibility of inspecting particularly the front quarters and reduces the risk of soiling by feces and urine for the milker. This is particularly effective in side-by-side milking parlours, in which there is a poor view of the cow and a poor opportunity to inspect the front quarters of a cow. It is preferably possible to milk off the first streams of milk in the preparation area, these being able to be used to check for visible changes, e.g. blood, flakes, etc. It is also possible for the udder and particularly the teats to be cleaned in the preparation area. If the udder and the teats are cleaned using a liquid, it is also possible for the udder, particularly the teats, to be dried in the preparation area. Furthermore, manual or automatic stimulation can take place in the preparation area.

If a multi-position milking installation is a carousel milking installation, in particular, the total time for which the cows are on the milking platform in line with the prior art is made up of times for entering the milking platform, the times for the performance of the preparatory actions on the animal, the milking time, i.e. the time in which the teat-cup cluster is on the udder, and the time between the removal of the teat-cup cluster and the milking platform being left. As a result of this method procedure for milking animals in a multi-position milking installation on the basis of the prior art, the multi-position milking installation is not used effectively. If the multi-position milking installation is one in which, by way of example, 80 milking positions are arranged on a rotatable milking platform, practical experience shows that approximately 18 of the milking positions are not used because they are being used for preparing the animal prior to the milking operation. Furthermore, approximately six positions in the entrance and exit areas are not used effectively. These six milking positions are used for access by the cows, for the cows to go down and for inspection of milking out or for disinfection of the teats. Of the 80 milking positions, cited by way of example, of a carousel milking installation, 24 milking positions are therefore not used effectively. The milking capacity of this installation is then approximately 373 cows per hour, if it is assumed that the teat-cup clusters are arranged on the cows' teats for approximately nine minutes.

By contrast, the inventive embodiment of the method achieves a higher level of effectiveness for the multi-position milking installation, particularly for a carousel milking installation. If a carousel milking installation with 60 milking positions is considered, for example, then, assuming that the teat-cup clusters are already attached to the udder one or two milking positions after the carousel entrance and 6 milking positions in the carousel entrance/exit areas are not used for milking, 52-53 milking positions are effectively available for milking.

Assuming that the teat-cup clusters are on the cows' teats for no more than approximately nine minutes, a milking capacity for the installation of 350 cows per hour is achieved. The inventive method procedure therefore achieves the milking capacity of a milking carousel with 60 milking positions, as illustrated by way of example, which corresponds to a conventional carousel milking installation with approximately 80 milking positions.

In line with one advantageous embodiment of the method, it is proposed that changes in the animals be recognized and possibly recorded in the preparation area, and depending on the result of the recognition the relevant animal not be transferred to the milking area.

This measure ensures that animals which have mastitis, for example, are milked separately, so that the only milk which can be used is obtained in the multi-position milking installation.

In line with yet another advantageous embodiment of the inventive method, it is proposed that the animals' state of health be checked in the preparation area. The fact that the preparation area precedes the milking area and actions are accomplished therein has provided a way of providing the operating personnel with sufficient time to check the animal's state of health.

The inventive multi-position milking installation comprises at least one entrance area and at least one exit area. The at least one entrance area and the at least one exit area have at least one milking area, which comprises a plurality of milking positions, provided between them. The at least one entrance area is preceded by at least one preparation area, in which it is possible to perform at least one action preparing for a milking operation. Provided adjacent to the at least one preparation area is at least one work area. It is possible for the milker to move within the work area. The apparatuses and materials required for performing the actions are also provided therein.

Particular preference is given to a multi-position milking installation in which the at least one preparation area is arranged between two work areas. This provides the option of performing the actions on both sides of the preparation area.

In line with yet another advantageous embodiment of the multi-position milking installation, it is proposed that the at least one preparation area and the entrance area have at least one operatable shutoff means provided between them which is suitable and intended for preferably selectively opening the entrance area to at least one animal. The effect achieved by means of this measure is that animals cannot enter the entrance area of the multi-position milking installation until the at least one action has been performed in the preparation area.

According to yet another advantageous embodiment of the multi-position milking installation, it is proposed that the at least one preparation area have at least one operatable shutoff means which is suitable and intended for preferably selectively opening the preparation area to at least one animal.

This measure ensures that at least one animal can be restrained within the preparation area until the preparatory actions have been performed.

Particular preference is given to a multi-position milking installation in which the at least one preparation area and the at least one entrance area have at least one selection area provided between them from which at least one animal can be transferred to the entrance area or to a treatment area.

The effect achieved by this measure is a selection of the animals, so that only the animals which are actually also intended to be milked can move to the milking position. Animals which are not intended to be milked, for example because they are sick, can be transferred from the preparation area to a treatment area.

To increase the efficiency of the multi-position milking installation still further, yet another advantageous embodiment of the multi-position milking installation involves the proposal that a plurality of preparation areas and work areas be arranged next to one another.

The preparation area may be in the form of a corridor, for example. Particular preference is given to the embodiment of a preparation area which has at least one preparation box. A box is also understood to mean a preparation position which is provided for preferably just one animal.

To simplify determination of the animals, it is proposed that identification means be provided. The identification means may preferably be positioned in the preparation area and/or entrance area. Each animal can carry an appropriate identification means which is read in the preparation area and/or entrance area. The preparation means may be active or passive identification means, particular RFID units.

In line with yet another advantageous embodiment of the multi-position milking installation, it is proposed that the at least one work area have means for data input and/or data output. This option provides a milker in the work area with information about the animal which is in the preparation area. He can evaluate these data and possibly update the data record for an animal by inputting new data.

The inventive embodiment of the multi-position milking installation is particularly suitable for large herds. To simplify the management and the provision of extensive information about the animals, it is proposed that at least one data processing installation be provided which is connected to the identification means and/or to the means for data input and/or data output for signaling purposes. The data processing installation can be used to operate herd management.

Further advantages and details of the invention are explained with reference to the exemplary embodiments illustrated in the drawings, without the subject matter of the invention being limited to these specific exemplary embodiments.

In the drawings:

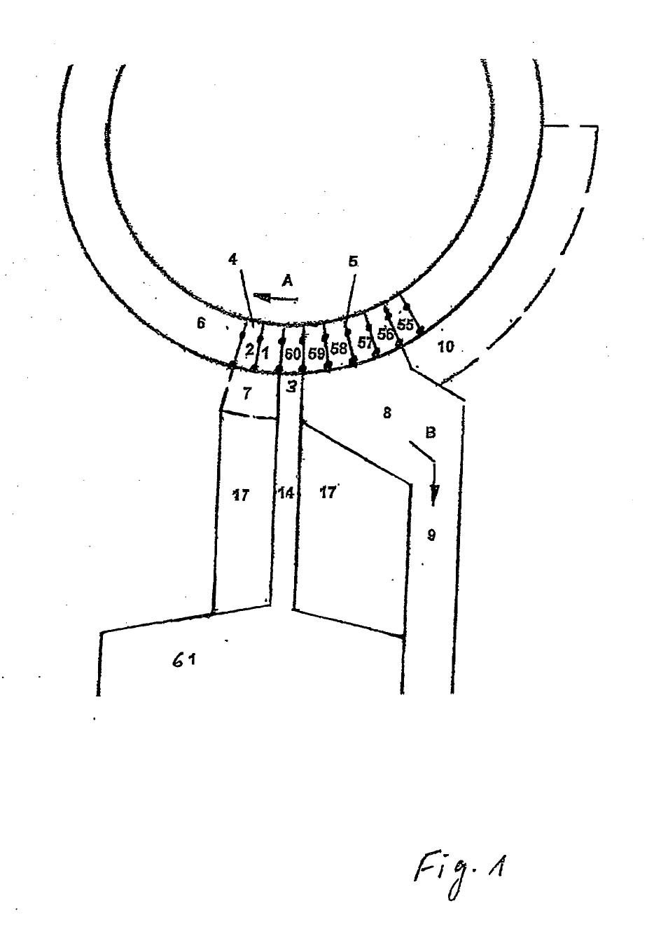

FIG. 1 shows a first exemplary embodiment of a multi-position milking installation, with a preparation area,

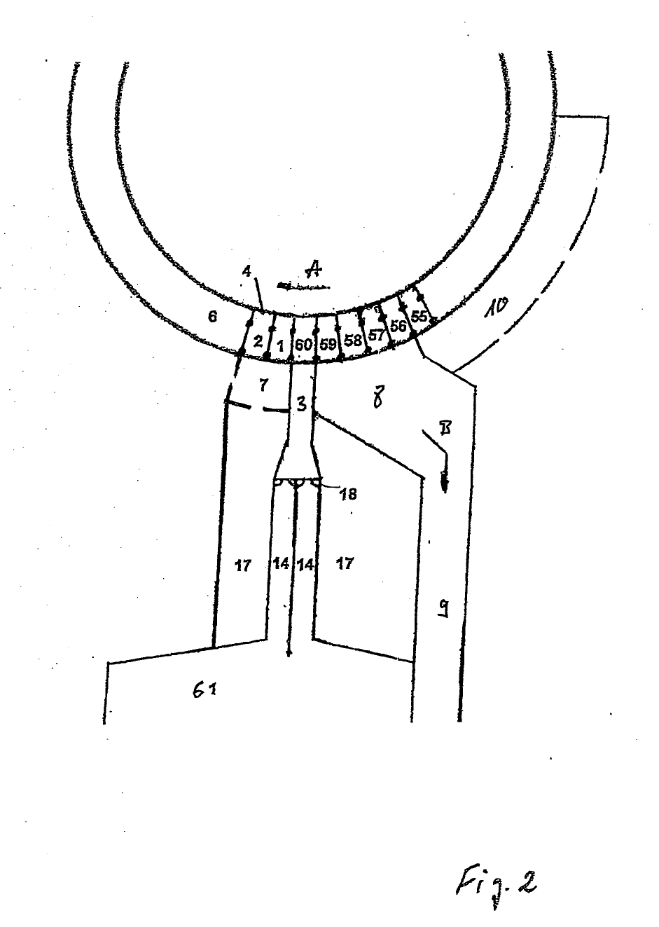

FIG. 2 shows a second exemplary embodiment of a multi-position milking installation with two preparation areas arranged parallel to one another,

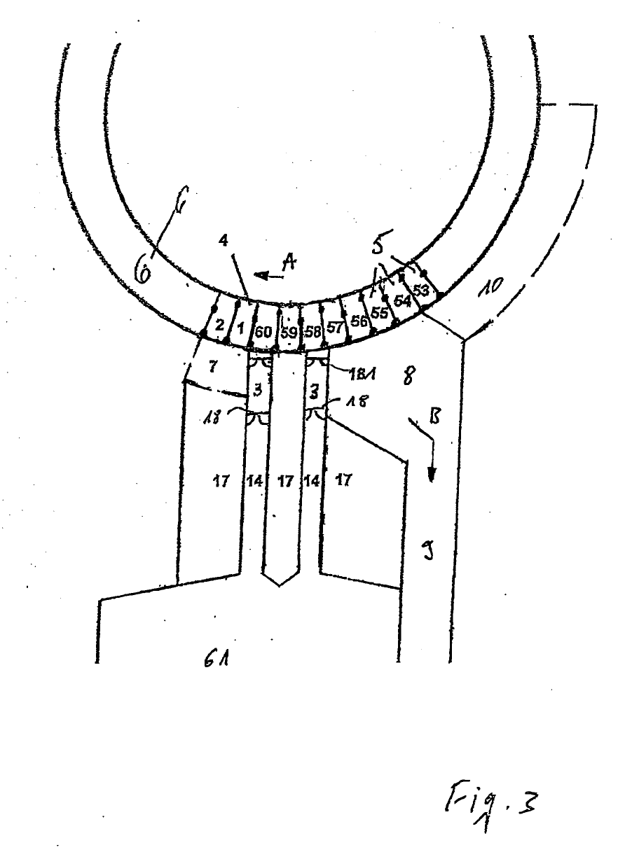

FIG. 3 schematically shows a third exemplary embodiment of a multi-position milking installation with two entrance areas and two preparation areas,

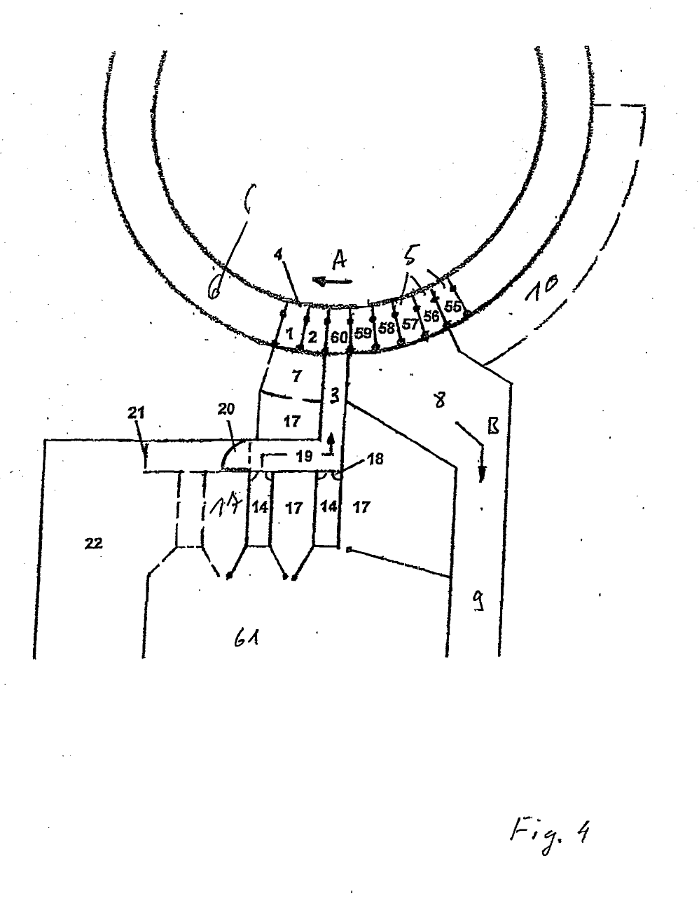

FIG. 4 shows a multi-position milking installation with a plurality of preparation areas arranged parallel to one another,

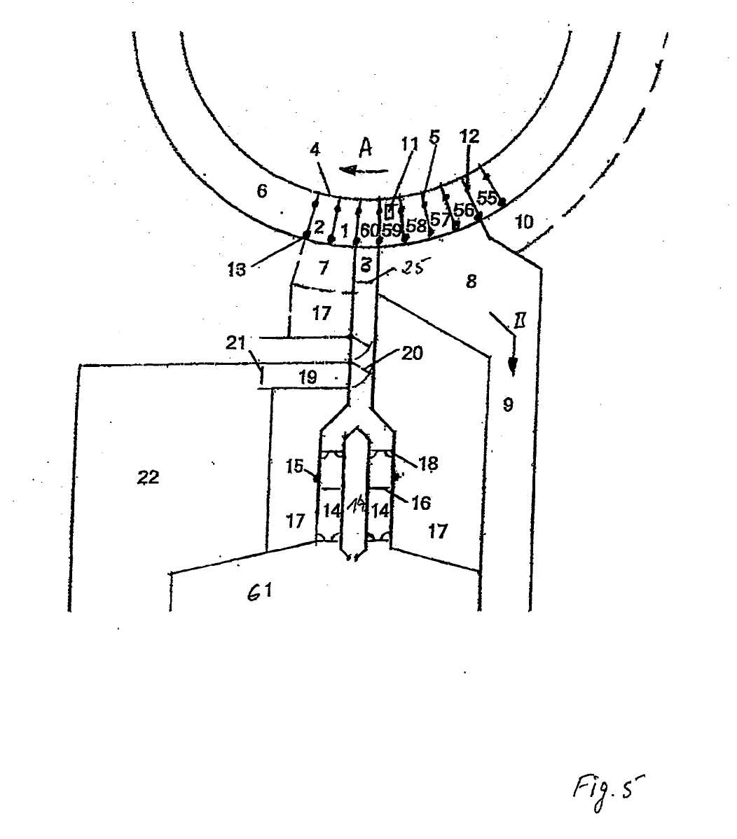

FIG. 5 schematically shows a further exemplary embodiment of a multi-position milking installation with two preparation areas arranged parallel to one another,

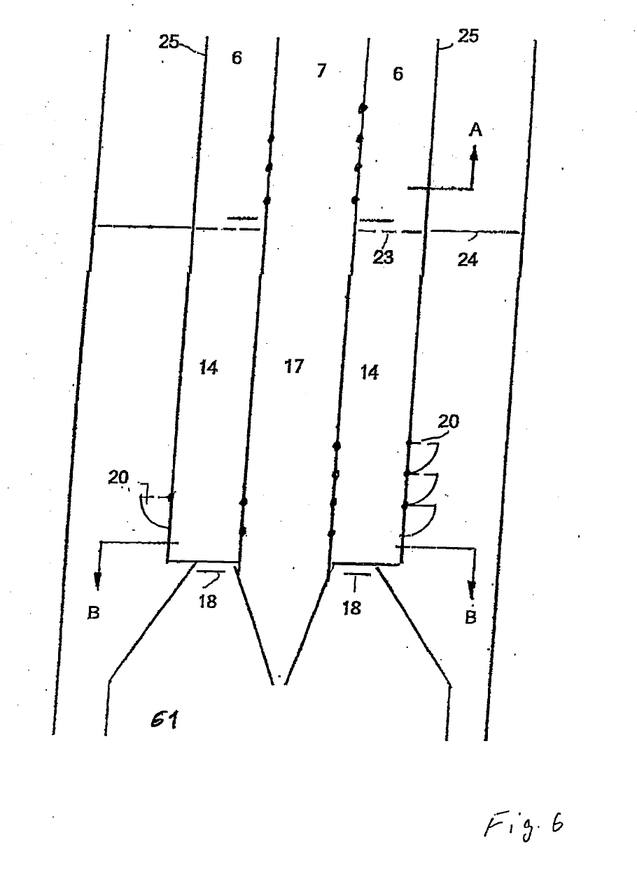

FIG. 6 shows a sixth exemplary embodiment of a fixed multi-position milking installation.

FIG. 1 schematically shows a first exemplary embodiment of a moving multi-position milking installation. The multi-position milking installation is shown schematically. It has a carousel milking installation. This carousel milking installation comprises a rotatable milking platform 4. Milking positions 5 are formed on the milking platform 4. As shown by the illustration in FIG. 1, the carousel milking installation has 60 milking positions, some of the milking positions being identified by means of the reference symbols 1, 2 and 55 to 60.

For the purpose of entering the carousel milking installation or the individual free milking positions, the carousel milking installation is preceded by an entrance area 3 which allows the cows to enter the rotatable milking platform 4.

The cows which have been subjected to a milking operation on the milking platform leave the milking platform 4 via an exit area 8. The animals can leave the milking installation via a drive-back path 9.

The entrance area 3 is preceded by a preparation area 14 in which it is possible to perform at least one action preparing for a milking operation. Provided adjacent to the preparation area 14 in the exemplary embodiment shown in FIG. 1 are two work areas 17.

The animals to be milked move from a waiting area 61 into the preparation area 14. If necessary, the waiting area 61 may be equipped with driving aids, particularly automatic driving aids, so that the animals are driven out of the waiting area 61 into the preparation area 14. When individual animals are in the preparation area, the personnel can perform the necessary operating routines for udder preparation from the two work areas 17.

The length of the preparation area 14 is essentially based on the work effort required for preparing animals for milking. The animals can then move individually to the milking positions via the entrance area 3.

In the work area 7, the operating personnel can attach the teat-cup cluster to the animal's teats.

In the direction of rotation A of the milking platform 4, the exit area 8 is preceded by an area 10 which is shown in dashes in the exemplary embodiment shown. By way of example, a milker can perform further actions subsequent to the milking operation in this area 10, for example disinfecting the teats. It is also possible for post-milking inspection or other actions to be performed in this area.

The illustration in FIG. 1 shows that of the 60 milking positions only 8 milking positions are not used for milking. At milking positions 1 and 2, the teat-cup clusters are attached. Milking position 60 is used for access by a cow. Milking positions 56 to 59 are used for the cow to exit the milking platform. By way of example, milking position 55 is used for disinfecting the teats after milking and/or for udder inspection.

The effectively usable area of the carousel milking installation is identified by the reference symbol 6.

The inventive embodiment of the method and of the apparatus allows more effective utilization of the milking installation. The milking capacity of the multi-position milking installation is increased, so that multi-position milking installations with fewer milking positions can be used for the same or similar milking capacity as is possible on the basis of the prior art, which has a cost-reducing effect on overall investment for buildings, milking installations, etc.

Particularly the udder preparation in the preparation area improves the general view of the animals and the opportunity for inspection, particularly of the front quarters. Furthermore, a risk of soiling through feces and urine is reduced for the milker.

FIG. 2 shows a second exemplary embodiment of the inventive multi-position milking installation. The basic design of the multi-position milking installation shown in FIG. 2 essentially matches the design of the multi-position milking installation shown in FIG. 1. The same reference symbols are used for identical parts.

The multi-position milking installation shown in FIG. 2 differs from the multi-position milking installation shown in FIG. 1 in that two preparation areas 14 arranged essentially parallel to one another are provided. The preparation areas 14 and the entrance area 3 have a respective operatable shutoff means provided between them. The shutoff means 18 restrain the animals in the preparation area until the actions which are required and expedient have been performed. The shutoff means may be swing gates which open the preparation area, so that animals can pass from the preparation area 14 into the entrance area 3. Preferably, the shutoff means 18 are operated automatically. To this end, an appropriate switch may be provided in the work area 17, for example, which switch can be operated by an operator when the actions to be performed on the animal have been performed and the animal can be transferred to the entrance area 3. If appropriate, the entrance area 3 may be provided with appropriate sensor means, so that the shutoff means 18 can be operated only when the entrance area has become free such that an animal can pass from the preparation area to the entrance area and the shutoff means can be closed again behind the animal.

FIG. 3 shows yet another exemplary embodiment of an inventive multi-position milking installation. The multi-position milking installation comprises a carousel milking installation with a rotatable milking platform 4 on which milking positions 5 are arranged.

The exemplary embodiment shown in FIG. 3 has two entrance areas 3. Each entrance area 3 is preceded by a preparation area 14. The illustration in FIG. 3 shows that the preparation areas 14 have an work area 17 arranged between them. The embodiment of the multi-position milking installation thus has two preparation areas 14 and three work areas 17, with an operator preferably being able to perform actions either in one or the other preparation area preferably from the middle work area 17, that is to say the one situated between the two preparation areas 14.

The access from the preparation areas 14 to the entrance areas 3 is severed by means of shutoff means 18. The access is closed for as long as the entrance area 3 is not open and/or the preparation actions in the preparation area have not yet been concluded.

The reference symbol 181 denotes a further shutoff means which can open or close the access from the entrance area to the milking platform. The shutoff means 18 or 181 are optional and form preferred embodiments of the inventive multi-position milking installation. The shutoff means are preferably connected to a controller—not shown. Particular preference is given here to an embodiment of the multi-position milking installation in which the shutoff means 181 are alternately opened and closed.

The arrangement of two entrance areas doubles the setup time for the animals in the preparation area, so that the animals can remain in the preparation area for longer.

FIG. 4 shows yet another exemplary embodiment of an inventive multi-position milking installation. This exemplary embodiment is also provided with a milking platform 4 having milking positions 5. For the purpose of performing at least one action on the animal in preparation for a milking operation, preparation areas 14 are provided. Work areas 17 are formed adjacent to the preparation areas 14. Each preparation area 14 is connected to a corridor 19 which leads into the entrance area 3. The preparation areas 14 may be in the form of boxes which can be shut off from the corridor 19 by means of shutoff means 18. A further preparation area 14 is shown in dashes. The embodiment shown in FIG. 4 opens up the opportunity to extend the preparation areas and the work areas.

A sorting diverter 20 is shown in the corridor 19 in the exemplary embodiment shown. The sorting diverter 20 ensures that an animal can pass from the preparation area 14 into a treatment area 22. An apparatus 21 which separates or opens the corridor 19 from/to the treatment area 22 is used to ensure that an animal cannot move from the treatment area 22 into the corridor 19.

Instead of a sorting diverter 20 in the corridor 19, the shutoff means 18 may be in a form such that they shut off the corridor 19, so that an animal can be transferred either to the treatment area 22 or to the entrance area 3. The operation of the shutoff means 18 and/or of the sorting diverter 20 and possibly of the apparatus 21 is preferably such that control ensures that clear paths are provided for an animal.

FIG. 5 schematically shows the plan view of yet another exemplary embodiment of a multi-position milking installation. The multi-position milking installation has a milking platform 4 on which milking positions 5 are arranged. The animals can individually enter the milking positions via an entrance area 3. The entrance area 3 contains an identification unit 25 which can identify the individual animals. To this end, the animals are provided with identification means. After the animals have individually taken up the milking positions, they are milked while the milking platform 4 rotates. In the work area 7, the teat-cup clusters are attached to the animals' teats. The individual milking positions may be equipped with appropriate data input and data output units 13. Furthermore, each milking position may have a recognition unit which ascertains which animal is at the milking position on the platform. The individual milking positions may have identification means which can be used to identify the milking positions as such. For this purpose, a milking position recognition unit 11 which is arranged at a fixed position may be provided, for example.

The entrance area 3, which allows the animals to enter the rotatable milking platform, is preceded by a required number of preparation areas 14. In the exemplary embodiment, two preparation areas 14 are provided. The preparation areas 14 are in the form of boxes. The number and length of the boxes are essentially based on the work effort required for the preparation, particularly on the degree of soiling of the teats and the udder and the efficiency of the operator.

Each preparation area 14 is equipped with a shutoff means 18. At least one sorting diverter 20, which is arranged between the shutoff means and the entrance area 3, is used to ensure that, by way of example, an animal can enter a treatment area 22 via a corridor 19 when required. An apparatus 21, which is arranged in the corridor 19, is used to ensure that an animal cannot enter the corridor 19 from the treatment area.

The exemplary embodiment shown in FIG. 5 shows two sorting diverters. Each sorting diverter opens a corridor 19. The number of sorting diverters, of corridors 19 and of further areas connected to the corridors 19 is dependent on the number of sorting criteria. If necessary, it is also possible for a plurality of sorting diverters to be arranged in a corridor 19, so that the animals can be sorted.

In the exemplary embodiment shown, each preparation area 14 has an animal recognition unit 16 and a milking position terminal 15. The animal recognition unit and the milking position terminals can be used by the operator to provide data. The terminal may also be in a form such that the operator can input data. Furthermore, the operator can use the terminal to operate the shutoff means 18 and the sorting diverters 20.

It is also possible for the shutoff means 18 and the sorting diverter 20 to be operated automatically. To this end, a controller is provided which takes the data for the animal and possibly the data entered by an operator as a basis for actuating the shutoff means 18 and the sorting diverter 20 as appropriate.

The controller, the milking position terminals, the identification means and other units of the multi-position milking installation may be connected to a herd management system. To this end, a data processing installation may be provided which stores the data for the animals or has a memory in which the data are stored. Furthermore, the individual actions on the animal can be stored. The herd management system can additionally provide information about individual animals to the operator in the work/preparation area.

Yet another exemplary embodiment of a multi-position milking installation is shown in FIG. 6. From a waiting area 61, the animals enter a preparation area 14. In the exemplary embodiment shown, two preparation areas 14 are provided which have an work area 17 arranged between them. The preparation areas 14 can be found by the animals when the access, which can be shut off by means of shutoff means 18, is opened. In the exemplary embodiment shown, the preparation areas 14 are formed with sorting diverters or exit gates 20, so that the animals can leave the preparation area 14 either via a sorting diverter 20 or via a connecting gate 23 depending on the result of the action. When the animal is driven or guided out of the preparation area 14 via the sorting diverter 20, it can enter a treatment area or another area—not shown.

The preparation area 14 is adjoined by the entrance area to the milking area 6. By way of example, the milking area 6 may be in the form of a side-by-side milking parlour or another milking parlour, preferably with “rapid exit”.

The animals leave the milking area 6 via an outlet apparatus 25, so that further animals can enter the milking area 6.

A shutoff mechanism 24 ensures that the animals can leave the multi-position milking installation only in the direction of the arrow A after leaving the milking area 6.

The invention has numerous advantages. In particular, increased efficiency of the technology used is achieved. Preferably, animal recognition takes place in the preparation area using an animal recognition system. The animal number or, in general terms, the identity tag of the animal is sent to a central computation unit, which sends an animal-specific data record to the animal recognition system, and the animal recognition system takes whether a sorting marker has been set for the relevant animal as a basis for generating an activation signal, which results in movement from a normal position to a sorting position on the sorting apparatus and hence guidance of the animal into a treatment space before the entrance.

Before the preparation area, the animals can be selected for milking or for treatment.

If a plurality of preparation areas are provided, visual and/or audible signals can be used, for example, to provide information in the work area to notify the operator when an animal needs to be prepared, so that said animal can enter the milking area in good time.

When a plurality of preparation areas are used, counting apparatuses may be provided in order to be able to prepare a number of animals which corresponds to the number of milking positions in group milking parlours.

The plurality of preparation areas are preferably arranged before an entrance to the milking platform.

If the carousel milking installation is a side-by-side milking installation, it is preferred if at least two entrances to the milking platform are provided and each entrance has an associated preparation area, which provides the operating personnel with more time for preparing the animals for milking.

Particular preference is given to an embodiment in which two or more preparation areas are arranged parallel to one another before the entrance to the milking platform, and each preparation area is equipped with at least one shutoff means and at least one sorting means and these allow animals to be routed either to the milking platform or to a treatment area as required.

For the purpose of eliminating the animals before the entrance, a plurality of sorting means may be provided in order to sort animals on the basis of two or more sorting criteria.

The treatment space and the corridor may have an apparatus arranged between them which allows the animals to access the treatment space from the corridor but automatically prevents animals from being able to return to the corridor from the treatment space.

A fixed milking parlour installation may be preceded by a milking area a preparation area. Preferably, there are as many preparation positions provided as the milking installation has milking positions. The preparation area preferably contains each preparation position a sorting means which provides the option of eliminating animals which are not permitted to enter the milking area.

Animals can be selected either manually or automatically. These options may also be provided alongside one another.

### LIST OF REFERENCE SYMBOLS

1-2 Milking position
3 Entrance area
4 Milking platform
5 Milking position
6 Milking area
7 Carousel entrance work area
8 Exit area
9 Drive-back path
10 Carousel exit work area
11 Milking position recognition unit
12 Onboard milking position terminal
13 Onboard recognition means (for milking box)
14 Preparation area
15 Fixed milking position terminal
16 Preparation area animal recognition unit
17 Preparation area work areas
18 Shutoff means
181 Shutoff means
19 Corridor
20 Sorting diverter
21 Nonreturn means
22 Treatment area
23 Connecting gate
24 Shutoff mechanism
25 Milking area animal recognition unit
55-60 Milking positions
61 Waiting area

1. A method for milking a dairy animal, the method comprising the steps of:
a) bringing a dairy animal to a preparation area;
b) preparing the dairy animal for a milking operation;
c) transferring the dairy animal from the preparation area to a milking area;
d) attaching a teat-cup cluster to the dairy animal's teats in the work area; and
e) performing a milking operation on the dairy animal.

2. The method of claim 1, and further comprising the steps of:
determining whether there are any changes in the dairy animals; and
preventing the dairy animal from entering the milking area if a change is determined.

3. The method as claimed in claim 1, and further comprising the step of:
checking the dairy animals' state of health in the preparation area.

4. A dairy parlor comprising:
an entrance area;
an exit area;
a milking area comprising a plurality of milking stalls and disposed between the entrance area and the exit area;
a dairy animal preparation area, preceding the entrance area; and
a work area adjacent to the preparation area.

5. The dairy parlor of claim 4, and further comprising a second working area, and wherein the preparation area is disposed between the first work area and the second work area.

6. The dairy parlor of claim 4, and further comprising:
a sort gate disposed between the preparation area and the entrance area.

7. The dairy parlor of claim 4, and further comprising:
a sort gate disposed adjacent to the preparation area.

8. The dairy parlor of claim 4, and further comprising:
a selection area disposed between the preparation area and the entrance area.

9. The dairy parlor of claim 4, and further comprising:
a plurality of preparation areas; and
a plurality of work areas are arranged next to one another.

10. The dairy parlor of claim 4, and further comprising:
a preparation box disposed in the preparation area.

11. The dairy parlor of claim 4, and further comprising:
a dairy animal identification device.

12. The dairy parlor of claim 4, and further comprising:
a data input disposed in the work area.

13. The dairy parlor of claim 11, and further comprising:
a data processing installation connected to the dairy animal identification device.

14. The dairy parlor of claim 4, and further comprising:
a data output disposed in the work area.
